(19) United States
(12) Patent Application Publication
(10) Pub. No.: US 2016/0334337 A1
(43) Pub. Date: Nov. 17, 2016

(54) ANALYSIS KIT FOR IDENTIFICATION OF DRUGS

(71) Applicant: Markus Mayer, Lindau (DE)

(72) Inventor: Markus Mayer, Lindau (DE)

(73) Assignee: Rose Plastic AG, Hergensweiler/Lindau (DE)

(21) Appl. No.: 14/712,199

(22) Filed: May 14, 2015

(51) Int. Cl. G01N 21/78; B01L 3/00

(52) U.S. Cl. CPC G01N 21/78; B01L 3/561; B01L 3/52; B01L 3/502; G01N 2021/752

(57) ABSTRACT

Analysis kit for identification of drugs, consisting of a shell-shaped upper part (2), which is connected to a shell-shaped lower part (3) at one side, so that it is pivotable by means of a film hinge (5), at least two separate holding chambers (26-28) suitable for holding a test fluid container (50) containing a test fluid are arranged in the lower part, wherein the respective test fluid container (50) is connected to a sample chamber (40), which holds the drug (56) to be tested, by flow channels (33-35) in a fluid-conducting manner.

The invention relates to a portable analysis kit for identifying drugs wherein a shell-shaped upper part is connected to a shell-shaped lower part by a film hinge so that it is pivotable on one side, the kit including at least two holding chambers that are suitable for holding a test fluid container that contains a test fluid.

In particular for testing for drugs and other substances held by consumers, it is necessary, at the site of seizure of the drug or other substance, to perform a test of which drug it is. Such a test is usually performed in an inhospitable environment under poor light conditions, so that one important requirement is that the analysis kit must operate reliably even under poor light and weather conditions. Such drugs include in particular heroin, cocaine, MDMA, ecstasy, speed, crack and other psychogenic drugs in a dry phase (powder, pills, tablets).

The goal of the invention is therefore to provide an analysis kit for identification of psychogenic drugs.

It is known that, for identification of psychogenic drugs, three different drug tests are to be performed in succession to clarify, step by step, which drug is involved.

It is known in this regard that a breakable test fluid container (an ampoule, for example) containing a first test fluid is provided in a test tube. Furthermore, it is known that this test fluid container may be provided in a test tube and, to perform the drug test, the stopper is removed from the drug tube and a test portion of the sample to be tested is added to the test tube. Then the test fluid container provided in the test tube is broken by pressing on the test tube, so that the test fluid flows out and enters the bottom region of the test tube. The sample is already present there and mixes with the test fluid.

Based on a visually discernible color change or some other chemical or thermal indication, it can now be ascertained which sample it is when mixing the test fluid with the sample to be tested.

If the test with the first test tube and the test fluid container packaged therein fails, then a second test tube is taken by providing a test fluid container with a second test fluid and adding a second test portion of the same sample in the test tube and performing the test. The test fluid container placed in the test tube is therefore broken by finger pressure on the test tube, and the test fluid mixing with the sample should indicate a visually discernible color change or the like, which is characteristic for that type of drug.

If the second drug test with the second test tube and the test fluid container placed therein should fail, it is known that a third test tube with a test fluid container introduced into it and a third test fluid contained therein may be used for a third test portion of the drug.

It is obvious that the known method of analysis is complicated because a total of three different test tubes with different test fluid containers must be taken along.

Another disadvantage is that larger amounts of drug samples must be available for testing because, if the test of the first test portion of the drug in the first test tube fails, then another test portion of the drug must be added to the second test tube, and if this test fails, a third test portion of the drug must be added to the third test tube.

Handling of three separate test tubes is difficult because a certain sequence, which is not necessarily apparent from the loosely stored test tubes, must be maintained in performing the tests.

Another disadvantage is that a relatively large amount of drug must be available if the drug must be divided into max. three different portions and tested in the individual test tubes.

The third disadvantage is that there are parts that can get lost, namely the sealing stopper for sealing the test tubes, for example, which must be placed back on the test tube somehow when the test of the sample has been performed, but this does not result in easy handling.

It is relatively time-consuming to perform max. three successive drug tests because one must first wait for the result of the first test fluid before the second test is initiated, etc.

Serial testing of several different drugs from different drug holders present at the same time is very time-consuming and is associated with the risk that the respective drug holder will destroy the drugs or otherwise dispose of them.

The object of the invention is therefore to improve upon an analysis kit for performing identification tests on substances of the type defined above, so that multiple drug tests can be performed more rapidly, using fewer individual parts and therefore being more reliable in operation and a reliable indication of the test result is ensured when using smaller amounts of sample.

To solve the problem as formulated, as herein further described includes a shell-shaped upper part that is connected by a film hinge to a shell-shaped lower part so that it is pivotal on one side. The kit includes at least two holding chambers for holding a test fluid container. Flow channels provide a fluid-tight connector between the test fluid container and a sample chamber wherein the drug to be tested is located.

The analysis kit contains at least two separate holding chambers each for holding a test fluid container, wherein each test fluid container contains a different test fluid, and the holding chambers have a fluid-tight connection to a test chamber, in which the drug to be tested is placed.

With the given technical teaching, the advantage now achieved is that multiple holding chambers are arranged in a single analysis kit, and each holding chamber holds a test fluid container.

For the sake of a simpler description, it is assumed in the following description that a total of three holding chambers with three different test fluid containers are provided in one analysis kit, although the invention is not limited to this.

The invention therefore relates in general to an analysis kit having at least two separate holding chambers, a breakable or separable test fluid container being placed in each.

The test fluid container is connected by a fluid-conducting connection to a sample chamber that is located a distance away from the respective holding chamber and holds the drug to be tested.

However, only for the sake of simpler description, three holding chambers and three test fluid containers are assumed, but that does not limit the invention. It is also possible to provide just two holding chambers and two test fluid containers, or even more than three may be provided.

The advantage of the disclosed analysis kit is simpler handling because several holding chambers with several test fluid containers are provided in one kit and care is taken through appropriate mechanical action on the test fluid container to ensure that the test fluid runs out and goes from the holding chamber through respective fluid-carrying channels into a sample chamber, where the drug is also located.

To introduce the drug into the sample chamber, there are various options, all of which are included in the presently disclosed invention.

In an embodiment of the invention, it is provided that the sample is introduced with a sampling tool, which is preferably designed as a sample spoon having spoon surfaces on one or both ends.

It is preferable if the sampling tool is pivotably connected to the analysis kit and can be detached from the analysis kit. The sampling tool can be detached by breaking it off, for example.

Thus the sample to be tested is placed in a sample chamber, which is preferably sealed with a swivel cover. The swivel cover is therefore first opened, thereby making the sample chamber accessible from above. A drug sample, for example, a small scoop of powder, is taken using the sampling tool and added to the sample chamber.

The sample chamber is preferably situated on the bottom of the analysis kit in the region of a collecting trough, and it is provided that a first test fluid container with a test fluid contained therein is opened first to perform the test.

In an embodiment, it is provided that the test fluid container is breakable. It is preferably made of a breakable glass or a breakable plastic, so that finger pressure on the analysis kit from the outside causes a cover arranged in the storage area of the test fluid container to sag flexibly inward and causes the test fluid container to break.

instead of breaking a test fluid container by manual finger pressure on the analysis kit from the outside, other withdrawal mechanisms may also be used. For example, it may be provided that the test fluid container is cut by a cutting tool that is operated by finger pressure or by a drilling tool or a tool that removes a sealing element from the test fluid container to thereby allow the test fluid to flow into a respective flow channel.

It is important that, with an arrangement of several holding chambers, each is connected to the sample chamber by half-open channels, so that it is always ensured that the test fluid can flow out of the open test fluid container and into the sample chamber.

In an embodiment of the invention, it is provided that the analysis kit is designed horizontally, i.e., the analysis kit is brought to a horizontal or slightly inclined position to perform the tests, wherein the holding chambers, in which the test fluid containers are held tightly, are placed at a slight inclination in the direction above the sample chamber.

Due to the slightly inclined position, it is ensured that the test fluid will flow into the sample chamber through the flow channel due to gravity.

In an embodiment of the invention, however, it may also be provided that the analysis kit is placed in an upright analysis position instead of in a horizontal analysis position. Then it is placed vertically on its bottom end face and the test fluid flows down vertically in the direction of the sample chamber placed at the bottom due to finger pressure on a test fluid container, which is held tightly in the holding chamber.

The advantage of the analysis kit herein disclosed is thus that, on the whole, several drug tests with different test fluids can be performed in a single kit, which thus permits a very space-saving design. Furthermore, this is a time-saving measure and offers greater operational reliability because three tests can be performed in rapid succession in one operating step without having to wait for the result of the first test or the second test.

Handling of such an analysis kit is much simpler because several drug tests take place in a single kit and are performed there, and no separate objects are present, such as sealing stoppers and the like, that would make the handling of the kit more difficult.

The sampling tool can be reconnected to the kit after performing the tests by locking it to the kit, for example, or clipping it to the kit and packing the kit into an outer package after performing the drug test to thereby ensure a kit that will stand up in court.

Based on the volume saved with this kit, since the analysis kit allows a plurality of drug tests in a small space, it is also possible to include a plurality of such multi-analysis kits in a common outer packaging container. This improves the overall view.

Using such multi-analysis kits, parallel tests can thus also be performed on different people holding drugs, who are possibly holding various drugs.

The sequence in performing the successive drug tests can be made easily identifiable visually by providing different visual fields on the analysis kit. It is therefore possible to make it definitely identifiable which field must be depressed first to open the test fluid container beneath it and to make the test fluid flow out.

The preferred kit size of such an analysis kit is approx. 100×32×12 mm, which yields a drug test that includes a variety of test substances and can be performed more easily and reliably in an intuitive manner.

In a preferred embodiment, the analysis kit is designed as a one-piece injection-molded kit having an integrated spoon or some other sampling tool. All the parts are produced in a single injection molding process.

When the analysis kit has been filled once with the test fluid containers, which are only placed in clamping holders, the analysis kit can be closed permanently or even sealed to prevent any influence on the test fluid containers held therein.

Likewise—as indicated above—the sequence in performing the tests can be indicated on the upper side of the analysis kit so that it is easily discernible visually.

After performing the tests, one after the other, the sample chamber can be closed easily by a respective swivel cover, which is preferably locked in place and prevents any new influence on the sample.

The analysis kit preferably consists of two parts that are pivotably connected to one another in the region of a film hinge at the side, namely an upper part and, pivotably arranged thereon, a lower part.

As an additional feature, the analysis kit also includes the advantage that certain measures are taken in the region of the flow channels, which prevent the test fluid from flowing back once it has flowed from the holding chamber into the sample chamber through the flow channel.

The subject matter of the present invention is derived not only from the subject matter of the individual patent claims but also from the combination of the individual patent claims with one another.

All the information and features disclosed in the documents, including the abstract, and in particular the three-dimensional embodiment disclosed in the drawings are novel individually and in combination.

The presently disclosed invention is not limited to individual subject matters that are referred to as “essential to the invention” or “important.”

The presently disclosed invention is explained in greater detail below on the basis of several drawings which illustrate several embodiments. Additional features of the presently disclosed invention and advantages of the presently disclosed invention can be derived from the drawings and the description herein.

They show:

FIG. 1: perspective view of an analysis kit according to the invention

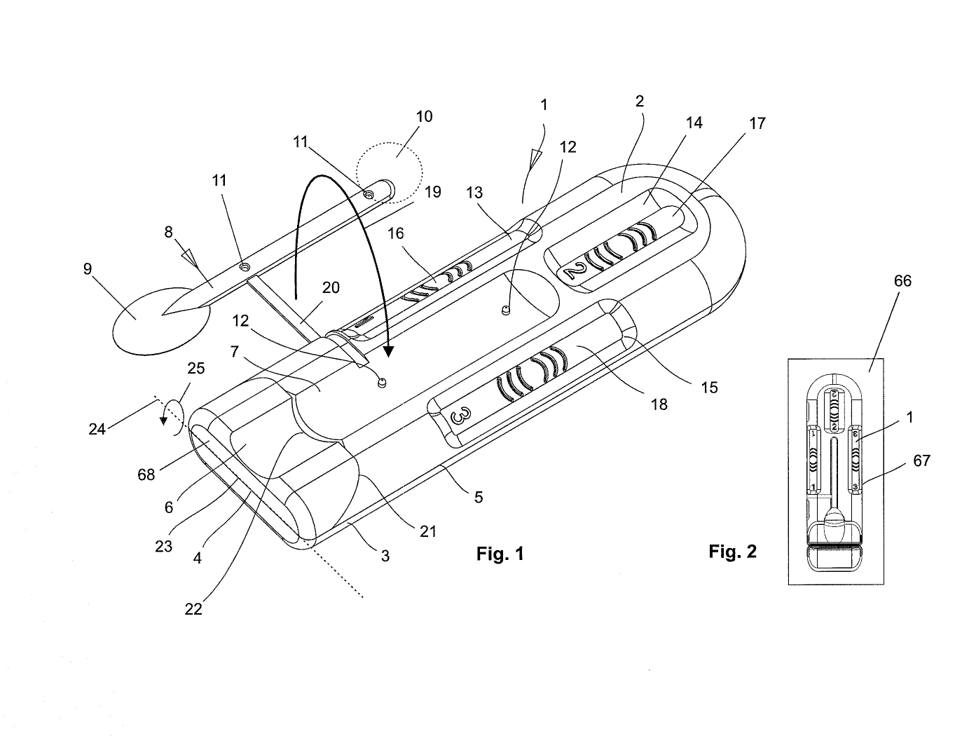

FIG. 2: top view of the analysis kit in the case when the kit is in a secondary package

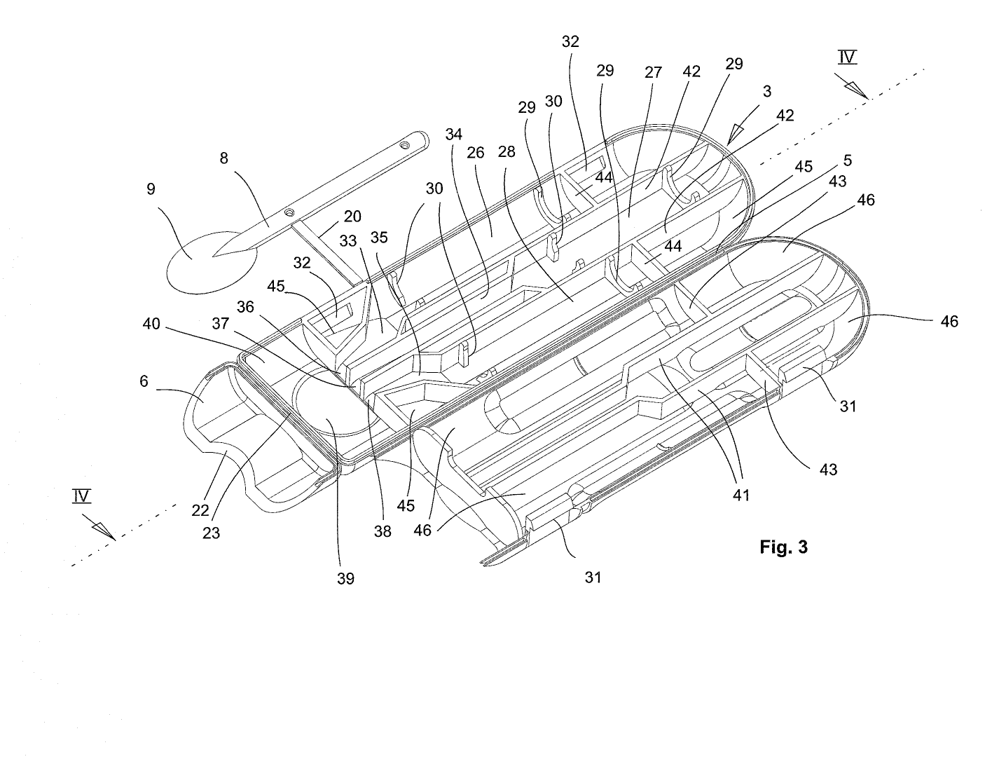

FIG. 3: perspective view of the analysis kit after being opened, not including the test fluid containers

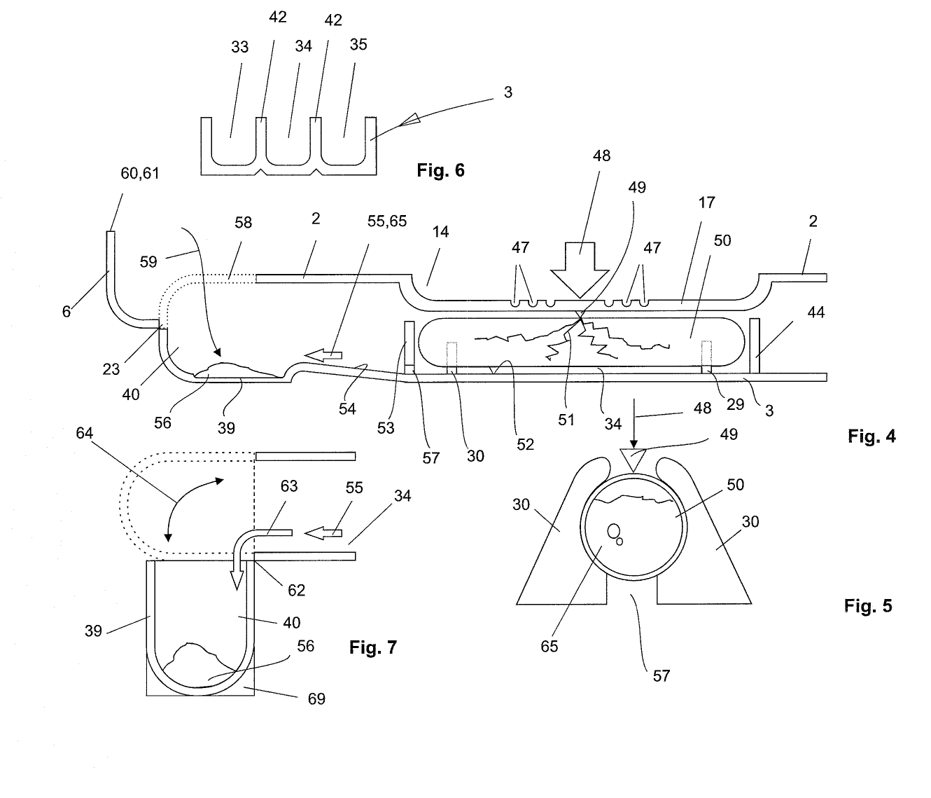

FIG. 4: section according to line IV-IV in FIG. 3 with a schematic diagram of the test procedure

FIG. 5: section through a test fluid container

FIG. 6: perspective front view of the flow channels in the lower part of the analysis kit

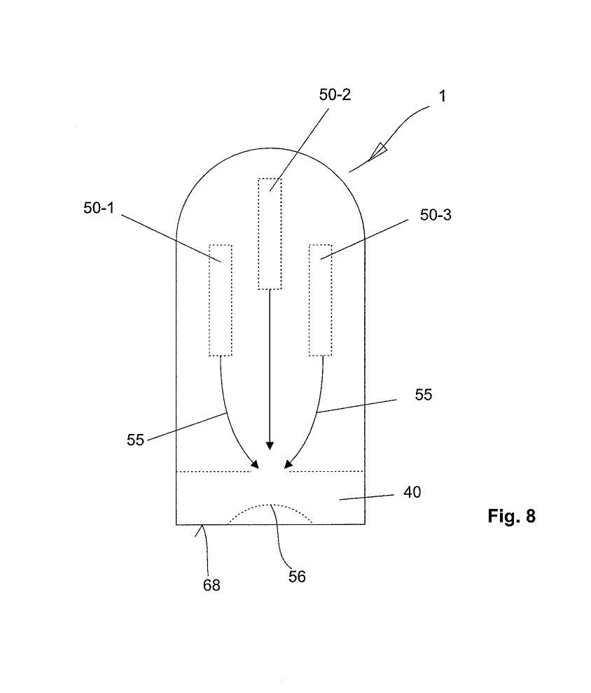

FIG. 7: a modified embodiment in comparison to FIG. 4, in which the sample chamber can be folded down

FIG. 8: a modified embodiment in comparison to FIGS. 1 and 3 in which the analysis kit is operated in an upright vertical position

FIGS. 1 and 3 show in general an analysis kit 1, consisting of an upper part 2 in the form of a cover, which is connected pivotably by a film hinge 5 to a lower part 3.

The two parts 2, 3 are made of injection-molded plastic, which is preferably designed to be transparent or at least translucent and consists of a suitable elastic plastic, for example, a polypropylene (PP) material.

The two parts 2, 3 can be separated from one another by a coupling joint 4. The two parts can be locked together, as shown in FIG. 3. Catches 31, which are designed to be elastic due to punched-out shapes and which can be locked in the respective latching recesses 32 on the side wall of the lower part 3, are provided on the side surface of the upper part 2.

The invention is also not limited to a PP plastic material. Any other suitable plastic material that ensures at least complete or partial transparency of the analysis kit or even transparency in only some regions.

In the rear region of the analysis kit 1, a cover 6, which forms a pivot axis 24 in a film hinge 23, is provided, so that the cover 6 can be opened in the direction of the arrow 25 from the lower part 3 (see FIG. 3).

In the upper region of the upper part 2, a holding space 7 that is open at the top is provided, a sampling tool 8 being accommodated therein.

FIG. 1 shows the sampling tool 8 after being pivoted out. In the exemplary embodiment shown here, this tool is designed as a spoon having a spoon head 9, which is possibly also attached to a second spoon head 10 in the opposite direction. Because the spoon head 10 must be present only as needed, it is shown with dotted lines. It is thus sufficient to provide a single spoon head 9.

The sampling tool 8 is pivotably connected to the upper part 2 by the holder 20 and, when pivoted in the direction of the arrow 19, the sampling tool 8 is pivoted into the holding space 7 that is open at the top.

The spoon can be separated from the holder 20 on the side of the spoon stem as well as on the side of the lower part of the analysis kit 1.

The sampling tool 8 is held by latching in the holding space 7 that is open at the top. Suitable snaps 12 pointing upward are therefore present on the bottom of the holding space 7 and cooperate with respective latching recesses 11 on the sampling tool 8. Any other lock engagement or releasable connection may of course be selected. Likewise, an adhesive bond or the like may be used.

In the boundary area of the analysis kit, three different protective recesses 13, 14, 15 are provided. The protective recesses have the purpose of protecting the test fluid containers 50 underneath from random damage in handling the analysis kit.

The upper sides of the protective recesses 13-15 are therefore recessed at the bottom with respect to the other peripheral boundary regions of the analysis kit 1.

Each protective recess 13-15 is closed by a bendable cover 16, 17, 18 wherein the respective cover is designed as a film or a thin flexible membrane, for example, and is also connected to the rest of the material of the analysis kit 1 in one piece with that material.

FIG. 4 shows as an example that such a cover 16-18 may be formed in the same wall thickness as the wall thickness of the upper part, 2 but then in this region of the cover 16-18, weakening grooves 47, which weaken the cover in the cross section, may be arranged in this region of the cover, ensuring that with a finger pressure applied to the cover 16-18 in the direction of the arrow 48, the test fluid container 50 underneath will break or will otherwise be opened in some other suitable manner.

The openable cover 6, which covers or opens the sample chamber 40 as needed, has a coupling joint 21 in the upper part 2, and a slot 22, which facilitates simpler handling, is provided in the region of the coupling joint 21. The slot is slightly widened and can be gripped with one finger in the slot to fold the cover 6 over about its pivot axis 24 in the direction of the arrow 25 and thereby open the sample chamber 40.

In conjunction with FIG. 4, it is also pointed out that a sealing edge 60 may be provided on the cover 6 or opposite it and the cover may also be connected to the upper part 2 with a latching connection 61.

FIG. 2 shows that the analysis kit 1 is accommodated in a secondary package 66, which is designed as a film pack or as a blister pack, for example. It is important that the secondary package 66 encloses the outlines 67 of the analysis kit 1 to thereby ensure the most sealed possible enclosure of the analysis kit.

FIG. 3 shows three different holding chambers 26, 27, 28, which are arranged in the lower part 3 of the analysis kit 1, each holding chamber 26-28 having a front clamp holder 30 and a rear clamp 29.

The clamp holder 29 is connected to the bottom side of the lower part 3 with a seal to prevent any flow of test fluid on this side.

However, according to FIG. 5, the clamp holder 30 arranged on the opposite side and at a distance has a flow opening 57, so that the test fluid flowing out of the broken test fluid container 50 can flow through the clamp holder 30 in the direction of the sample chamber 40.

FIG. 3 thus shows the three different holding chambers 26, 27, 28, each of which has clamp holders 29, 30 for a clamping hold on the test fluid container 50 arranged there.

Suitable dividing ribs 41, which correspond to the lower dividing ribs 42 in the lower part 3 and are flush and opposite one another when the analysis kit 1 is closed, are provided in the upper part 2.

Likewise, several transverse walls 43, which are flush with and opposite the respective transverse walls 44, are provided in the lower part 3 are also present in the upper part 2.

Corresponding empty spaces 45 in the lower part are also opposite the empty spaces 46 provided in the upper part.

A flow channel 33, 34, 35, each formed by the dividing ribs mentioned above, is designed at the outlet end of each holding chamber 26-28.

Each flow channel 33-35 is separated from the opposite flow channel in a fluid-tight manner, and the mouths 36-38 of the flow channels 33-35 open into a common sample chamber 40 according to FIG. 3, a recess collecting trough 39 to hold the drugs to be tested (drugs 56) being present at the bottom side thereof.

On the basis of FIG. 4, it will now be explained that to perform a drug test, the cover 17 is bent by finger pressure in the direction of the arrow 48, and a tip 49, which penetrates into the test fluid container 50, is arranged at the tip 49 and can break the test fluid container 50 into fine splinters, forming a fracture structure 51, to allow the test fluid 65 contained therein to flow out (see FIG. 5). The test fluid thus flows along the bottom surface 52 into the respective flow channel 33-35 in the direction of the sample chamber 40 in the direction of the arrow 55.

The one transverse wall 44 is impermeable to fluids and prevents the test fluid from running down, while the partition next to the sample chamber forms an inlet 53 for the test fluid into the sample chamber 40. A flow opening 57 is arranged in this area.

To prevent a return flow out of the sample chamber 40, namely out of the collecting trough 39 in the direction of the fluid container 50, it is preferable if an inclined ramp 54 is arranged in the bottom surface of the lower part 3 beyond the mouths 36-38, to thereby ensure that the test fluid will remain in the collecting trough 39 and that a return flow of the drug 56 in the direction of the holding chambers 26, 28 is also prevented.

FIG. 6 shows in general the arrangement of mutually parallel flow channels 33-35, wherein they preferably have rounded profile shapes to permit easy and undisturbed flow of the test fluid 65 in the direction of the sample chamber 40.

FIG. 4 also shows that when the cover 6 is open, the drug 56 to be tested is introduced from above in the direction of the arrow 59 and placed in the collecting trough 39.

Therefore, this yields an upwardly facing opening 58 through which the sample chamber 40 is accessible.

FIG. 7 shows a modified embodiment, in which it can be seen that the cover 6 can also be pivoted out as a complete part, which means that the sample chamber 40 is designed on the whole so that it can be pivoted downward. Then the cover 6 is omitted and instead a sample chamber 40 can be connected as a whole to the bottom surface of the lower part 3 in a pivot connection 62, and in the use position (analysis position) the test fluid 65 flows in the direction of the arrow 55 in the direction of the lower sample chamber 40 and conversely in the direction of the arrow 63, so that the test fluid 65 can be mixed easily with the drug 56 in the sample chamber 40 pivoted downward.

The entire sample chamber 40 is pivoted here in the directions of the arrows 64.

However, the invention is not limited to pivoting the sample chamber 40 away in the exemplary embodiment according to FIG. 7. It is also possible to provide that standing ribs 69 are arranged on the lower side of the sample chamber 40, so that to perform the tests, the analysis kit is placed upright and the sample chamber 40 is then pivoted upward in the direction of the arrow 64.

Such a vertical position of the analysis kit 1 is diagrammed schematically in FIG. 8. It is also shown there that it is not essential to the solution to design the sample chamber 40 to be pivotable at all.

The sample chamber may also be accessible from the side and may be provided as a closed compartment, with only side or front openings being provided. Here again, it is shown schematically that the entire analysis kit may be designed to stand vertically upright in the analysis position with the analysis kit standing either on the standing ribs 69 according to FIG. 7 or on the end surfaces 68 which are shown in FIG. 1.

The present invention thus makes it possible to operate the analysis kit in a horizontal position, in a slightly inclined position or in an upright position according to FIG. 8.

What is claimed is:

1. An analysis kit that cooperates with at least two test fluid containers to test drugs, said analysis kit comprising:
a shell-shaped upper part having at least one side;
a shell-shaped lower part having at least one side;
a hinge that connects the one side of said shell-shaped upper part to the one side of said shell-shaped lower part, said shell-shaped upper part and said shell-shaped lower part being pivotal between an open position and a closed position;
at least two holding chambers that are located in a space that is defined between said shell-shaped upper part and said shell-shaped lower part at times when said shell-shaped upper part and said shell-shaped lower part are in the closed position, each of said holding chambers being configured to receive a respective one of said test fluid containers;
a drug sample chamber; and
at least two flow channels, each of said flow channels corresponding to a respective one of said at least two holding chambers and defining a fluid tight connection between said respective flow chamber and said drug sample chamber.

2. The analysis kit of claim 1 wherein at least one of said shell-shaped upper part and said shell-shaped lower part includes at least one flexible cover such that a flexible cover corresponds to a respective one of each of said at least two holding chambers, each of said flexible covers being movable into said space that is defined between said shell-shaped upper part and said shell-shaped lower part at times when said shell-shaped upper part and said shell-shaped lower part are in the closed position to open a test fluid container that has been received in said respective holding chamber.

3. The analysis kit of claim 2 wherein said flexible cover fractures said test fluid container when said flexible cover is moved into said space that is defined between said shell-shaped upper part and said shell-shaped lower part.

4. The analysis kit of claim 1 further comprising a sampling tool that is releasably connected to said analysis kit.

5. The analysis kit of claim 1 wherein said each of said holding chambers includes respective clamping holders for holding a test fluid container that is received in corresponding holding chamber.

6. The analysis kit of claim 1 further comprising at least one return flow barrier that is located in a flow channel at a position in the flow channel between said sample chamber and said holding chamber that corresponds to said flow channel.

7. The analysis kit of claim 1 wherein said shell-shaped upper part is comprised of transparent material.

8. The analysis kit of claim 1 wherein said shell-shaped lower part includes a bottom side and wherein said sample chamber is connected to the bottom side of said shell-shaped lower part, said analysis kit further comprising a cover that cooperates with said sample chamber to close said sample chamber at times when said cover is in a closed position.

9. The analysis kit of claim 1 further comprising a pivot connection between said shell-shaped lower part and said sampling chamber such that said sampling chamber is pivotal downwardly with respect to said shell-shaped lower part to open the sampling chamber.

10. A method for operating an analysis kit for identifying drugs wherein said analysis kit is operable in a horizontal position and in an upright position and in a position that is inclined between said horizontal position and said upright position.
